(19) United States
(12) Patent Application Publication
(10) Pub. No.: US 2026/0074972 A1
(43) Pub. Date: Mar. 12, 2026

(54) Optimized Container-Based Network Intelligence

(71) Applicant: CAST AI Group, Inc., Miami, FL (US)

(72) Inventor: Andžej Maciusovic, Vilnius (LT)

(21) Appl. No.: 19/058,786

(22) Filed: Feb. 20, 2025

Related U.S. Application Data
(60) Provisional application No. 63/693,261, filed on Sep. 11, 2024.

(51) Int. Cl. H04L 43/062; H04L 43/045; H04L 47/2441

(52) U.S. Cl. CPC H04L 43/062; H04L 43/045; H04L 47/2441

(57) ABSTRACT

A system or method for optimizing network intelligence. An agent is deployed onto each node in a cloud environment. Each agent is executed within the kernel of its corresponding node and is attached to network-related system calls in the kernel. For each node, the agent monitors network-related system calls to observe incoming and outgoing network traffic and determines metrics associated with the network traffic based on the monitored network-related system calls. The system also identifies process-level network traffic flows based on the received metrics and a topology of the plurality of nodes in the cloud environment. The system classifies each of the process-level network flows into intra-zone or cross-zone based on traffic being local or external to a zone and generates and presents a graph for display corresponding to the process-level network traffic.

### CROSS REFERENCE TO RELATED APPLICATION

This application claims priority to U.S. Provisional Patent Application Ser. No. 63/693,261, filed Sep. 11, 2024, which is incorporated herein by reference in its entirety.

### TECHNICAL FIELD

This disclosure relates generally to cloud computing, and more specifically optimized container-based network intelligence.

### BACKGROUND

In cloud computing environments, such as Kubernetes-managed infrastructures, cloud providers typically do not offer adequate tools for observing fine-grained network traffic, such as network traffic at various granular levels, such as processes, containers, pods, and/or zones. This lack of visibility presents significant challenges in understanding network behavior and resource consumption, especially in dynamic and distributed environments.

For instance, when troubleshooting network issues, administrators frequently face difficulties in pinpointing the specific process or container responsible for initiating or receiving particular network connections. Without precise information about traffic sources and destinations, it becomes cumbersome or near impossible to isolate and resolve problems effectively. This gap in visibility is further compounded when multiple workloads share resources on a node, making it unclear which workload is causing network bottlenecks or resource contention.

In addition to trouble shooting challenges, performance degradation can occur when network nodes or zones become overloaded with traffic. Such scenarios may happen in cloud deployments, when traffic patterns are dynamic and unpredictable. Overloaded nodes or zones can lead to higher latency, reduced throughput, and overall diminished performance for applications. Moreover, cross-zone traffic, which occurs when data is transferred between different availability zones or regions, consumes more network resources compared to intra-zone traffic. These resource consumptions can quickly escalate, especially in high-traffic environments, significantly impacting the operational efficiencies of cloud-based applications.

### SUMMARY

The embodiments described herein address the above-described problems by monitoring network traffic data at kernels of nodes, determining metrics based on the monitored traffic data, and mapping the determined metrics with topology information of a cloud environment to generate a graph. The graph can then be used for managing, analyzing, and optimizing workloads and network traffic flows. For example, the graph can be used to reduce cross-zone traffic by migrating workloads or containers to the same zone, identifying bottlenecks or overloaded nodes for load redistribution or autoscaling, and/or detecting anomalies.

In some embodiments, a system deploys an agent onto each of a plurality of nodes within the cloud environment. Each agent operates within the kernel of its respective node, attaches to network-related system calls (e.g., socket operations), and collects data associated with network traffic flows originating from or received by the node. Data collected from each node includes at least a source address and a destination address associated with the network traffic flows.

The system also determines a topology of the plurality of nodes in the cloud environment by analyzing metadata associated with the plurality of nodes. Process-level network traffic flows are identified using the received data and the determined topology. Each process-level network traffic flow is classified as either intra-zone or cross-zone. A graph is generated and presented for display at a client device. The graph represents the topology of the network environment, with vertices corresponding to source or destination processes running on the nodes and edges linking vertices to represent process-level network traffic flows. The edges are annotated to indicate whether the corresponding traffic flows are intra-zone or cross-zone.

In some embodiments, the system can identify varying levels of granularity for network traffic flows by correlating network traffic flow data with the topology. These levels of granularity may include, but are not limited to, container-level traffic flows, pod-level traffic flows, node-level traffic flows, and zone-level traffic flows.

In some embodiments, the system identifies inefficiencies and optimizes workloads by determining traffic flow characteristics, such as whether flows are intra-zone or cross-zone, and acting on key metrics. For example, the system migrates containers or workloads from nodes with latency or traffic volume exceeding thresholds to nodes operating within the thresholds. In some embodiments, the system automatically provisions additional nodes and redistributes workloads when node traffic exceeds predetermined thresholds. As such, the system facilitates efficient cross-zone traffic management and ensures balanced resource distribution, enabling dynamic scalability and improved network performance.

### BRIEF DESCRIPTION OF THE DRAWINGS

FIG. 1 is a block diagram of a system environment in which an automation system with a network intelligence module may be implemented, in accordance with one or more embodiments.

FIG. 2A is a block diagram of a node in which a traffic collection agent is executed in a kernel to collect traffic flow data associated with the node, in accordance with one or more embodiments.

FIG. 2B is a block diagram of a Kubernetes cluster including multiple nodes, in each of which a traffic collection agent is executed in a kernel to collect traffic flow data associated with a corresponding node, in accordance with one or more embodiments.

FIG. 3 illustrates an example architecture of a network intelligence module in accordance with one or more embodiments.

FIG. 4 illustrates an example graphical user interface (GUI) that provides insights into network costs, traffic, and resource usage across workloads in a Kubernetes-managed environment, in accordance with one or more embodiments.

FIG. 5 illustrates another example GUI that visualize highest network traffic data flows over time, in accordance with one or more embodiments.

FIG. 6 illustrates an example GUI that visualizes performance metrics collected for a node where a target application is deployed in accordance with one or more embodiments.

FIG. 7 illustrates another example GUI that provides insights into network traffic in a Kubernetes-managed environment, in accordance with one or more embodiments.

FIG. 8 illustrates another example GUI that visualizes performance metrics and price metrics of multiple instance families in accordance with one or more embodiments.

FIG. 9 is a flowchart of a method for identifying process-level network traffic flows in accordance with one or more embodiments.

FIG. 10 is a block diagram of an example computer suitable for use in a networked computing environment in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

Cloud computing environments, such as Kubernetes-managed infrastructures, often lack tools for fine-grained network traffic observation. Cloud service providers do not provide detailed insights into traffic at levels like processes, workloads, nodes, or zones. This lack of visibility complicates understanding network behavior and resource usage in dynamic, distributed systems. On the other hand, some external tools collect excessive, irrelevant data, leading to high resource consumption (CPU, memory, storage) and operational overhead.

The embodiments described herein address the above-described problems by monitoring kernel-level network traffic data. In some embodiments, an automation system (hereinafter also referred to as “the system”) deploys agents onto kernels of nodes to monitor network-related system calls and collect data associated with network traffic flows, such as processes and workloads associated with each network traffic flow. The system correlates data associated with network traffic collected from different nodes to identify traffic flows across various granularity levels, such as process level, workload level, pod level, container level, node level, and/or zone level.

For example, in a Kubernetes environment, each cluster includes multiple nodes. Each node can host multiple pods. Each pod represents one or more containers that share a same network namespace, storage, and/or configuration. Each pod can contain one or more processes running inside their containers. An availability zone (referred to as an “AZ” or simply a “zone”) is a logical or physical partition within a region of a cloud provider's infrastructure. Network traffic within the same zone consumes fewer resources compared to traffic between different zones, as cross-zone traffic involves longer physical distances and passes through a greater number of network devices, such as routers, gateways, and switches.

Nodes in a Kubernetes cluster can be in same or different zones. The automation system collects data from kernels of nodes. The collected data may be mapped to entities like containers, pods, nodes, and zones, providing a comprehensive understanding of how traffic flows through an entire infrastructure. Moreover, the collected data may also be mapped to processes. Based on the mapping, the system can generate a graph linking nodes and/or processes, visualizing traffic patterns and highlighting cross-zone, inter-node, or process-level flows for insights.

Further, unlike some existing tools that often collect excessive, irrelevant data, leading to high resource consumption and operational overhead, the automation system described herein attaches an agent to network-related system calls in the kernel, capturing only relevant traffic metrics to reduce overhead. In some embodiments, the system performs in-kernel filtering and aggregation of traffic data by attaching agents to specific system calls, such as calls directly related to socket operations, data transmissions, and network interface operations. The agents are configured to aggregate and process the raw data in real time or near real time to determine metrics related to network traffic, significantly reducing an amount of raw data that needs to be processed or stored by each node or the automation system.

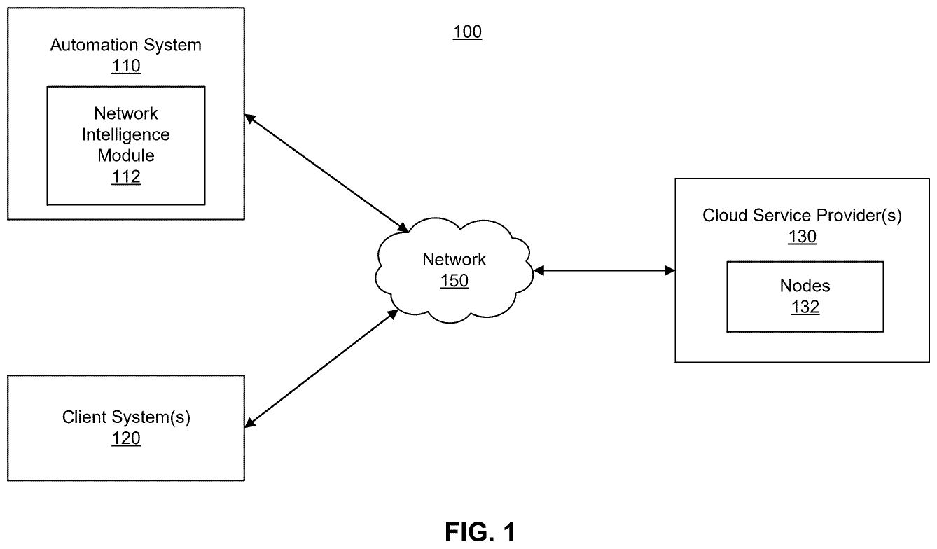

Additional details about the instance picker are further described below with respect to FIGS. 1-9.

### System Architecture

FIG. 1 is a block diagram of a system environment 100 in which an automation system 110 (also referred to “the system”) may be implemented in accordance with one or more embodiments. The environment 100 includes the automation system 110, one or more client devices 120, and one or more cloud service provider(s) 130, all interconnected via a network 150. The cloud service provider(s) 130 host one or more nodes 132, which may be virtual machines (VMs). The cloud service provider(s) 130 may include (but are not limited to) Amazone Web Services (AWS)®, Google Cloud Platform (GCP)®, and/or Microsoft Azure®. The cloud service provider (CSP) 130 provides computing resources, such as VMs, storage, and networking, over the network 150. VMs are scalable, software-based representations of physical machines that can run operating systems and applications. Networking includes virtualized network components, such as firewalls, and virtual private networks (VPNs). These resources may be made available to users on-demand, enabling flexibility and scalability. In some embodiments, the nodes 132 are part of a Kubernetes cluster, which is a distributed system for managing containerized applications across multiple VMs. Additional details about clusters and Kubernetes services are described in U.S. patent application Ser. No. 17/380,729, filed Jul. 20, 2021 (now issued as U.S. Pat. No. 11,595,306), which is incorporated herein in its entirety.

The network intelligence module 112 is configured to deploy an agent onto each of a plurality of nodes 132. Each agent is executed in a kernel of a corresponding node and attached to network-related system calls in the kernel of the corresponding node. Each agent is configured to monitor network-related system calls and collects information about network traffic flows based on the monitored network-related system calls. The network intelligence module 112 is also configured to collect metadata associated with each node (including containers, pods, and processes running on the node) in the network environment, and correlates the information about network traffic flows with metadata to identify process-level network traffic flows. The network intelligence module 112 can then generate a graph including the plurality of nodes and edges associated with the identified process-level network traffic flows between the plurality of nodes. Additional details about the agent and the network intelligence module 112 are further described below with respect to FIGS.' 2A, 2B, and 3.

The client device(s) 120 are computing systems associated with various entities. These entities include entities that can provision nodes 132 on the cloud service provider 130, as well as end-users who engage with applications deployed onto the nodes 132. The client devices 120 are also capable of receiving user input as well as transmitting and/or receiving data via the network 150. In one embodiment, a client device 120 is a computer system, such as a desktop or a laptop computer. Alternatively, a client device 120 may be a device having computer functionality, such as a personal digital assistant (PDA), a mobile telephone, a smartphone, or another suitable device. A client device 120 is configured to communicate via the network 150. In one embodiment, a client device 120 executes an application allowing a user of the client device 120 to interact with the automation system 110. For example, the client device 120 may execute a customer mobile application to enable interaction between the client device 120 and the automation system 110 or the cloud service providers. As another example, a client device 120 executes a browser application to enable interaction between the client device 120 and the system 110 via the network 150. In another embodiment, a client device 120 interacts with the system 110 through an application programming interface (API) running on a native operating system of the client device 120, such as IOS® or ANDROID™.

The network 150 is configured to facilitate communications among the automation system 110, client device 120, and cloud service provider 130. The network 150 may comprise any combination of local area and/or wide area networks, using both wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

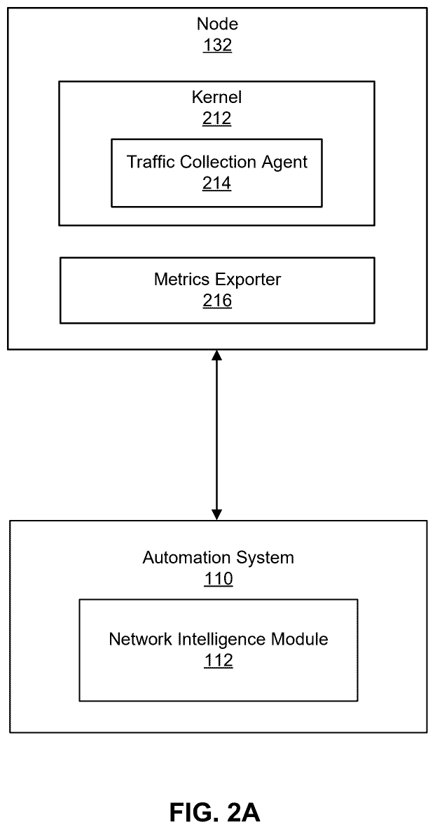

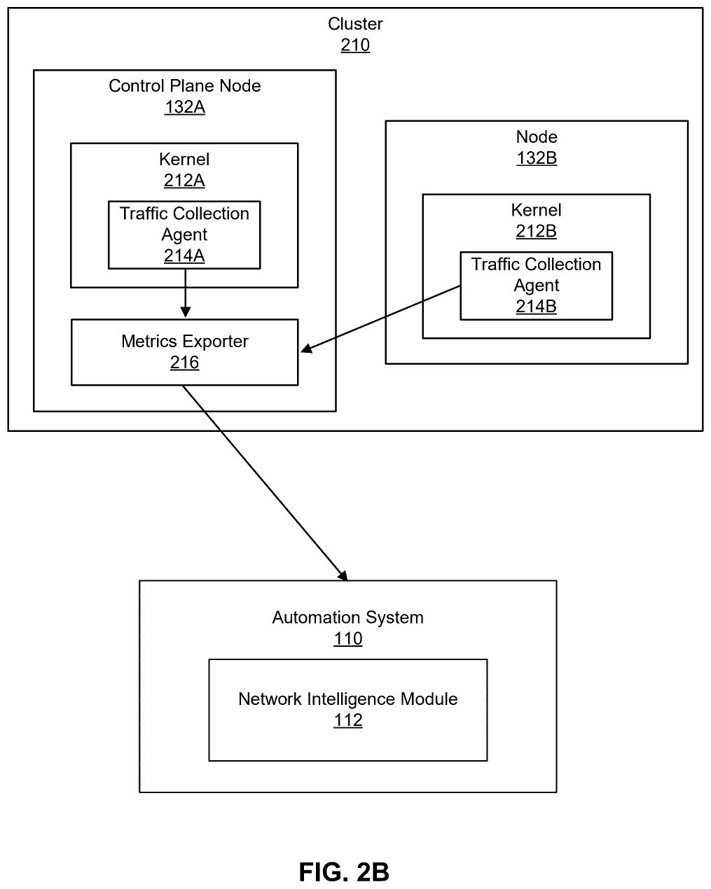

FIG. 2A is a block diagram of a node 132 in which a traffic collection agent 214 is executed in a kernel 212 of the node 132 to collect traffic flow data associated with the node 132 in accordance with one or more embodiments. The node 132 may be a virtual machine (VM) that is provisioned from a specific instance family offered by a cloud service provider, such as AWS®, Google Cloud®, or Microsoft Azure®. Cloud service providers offer predefined VM configurations grouped into instance families. An instance family represents a category of VMs with specific hardware specification. The node 132 includes a kernel 212. The kernel 212 is a component of a VM's operating system that directly interacts with virtualized hardware. The kernel 212 performs functions related to resource management (e.g., CPU scheduling, memory management, and I/O management), process management (e.g., handling process creation, scheduling, and termination within the VM, managing inter-process communication), and networking (e.g., providing an abstraction layer for network communication, interacting with virtualized network interfaces), and security (e.g., enforcing access control and isolation between processes to prevent unauthorized access).

A traffic collection agent 214 is deployed in the kernel 212 of the node 132, such that the agent 214 has privileged access to low-level system events. In particular, the traffic collection agent 214 observes incoming and outgoing network traffic by attaching to network-related system calls and kernel hooks in the network stack. In some embodiments, the attached network-related system calls include (but are not limited to) system calls related to socket management, such as socket( ) (which creates a new socket for communication), bind( ) (which binds a socket to a specific local IP address and port), listen( ) (which marks a socket as passive, allowing it to accept incoming connections), accept( ) (which accepts an incoming connection request on a listening socket), connect( ) (which establishes a connection from a client socket to a remote server), and/or close( ) (which closes a socket, terminating the connection).

In some embodiments, the attached network-related system calls include (but are not limited to) system calls related to data transmission, such as send( )/sendto( )/sendmsg( )/sendmmsg( ) (which send data over a socket), recv( )/recvfrom( )/recvmsg( )/recvmmsg( ) (which receives data from a socket).

In some embodiments, the attached kernel hooks include (but are not limited to) eBPF (Extended Berkley Packet Filter)-based hooks, netfilter hooks, tracepoints, kprobes and/or uprobes. The eBPF-based hooks may include (but are not limited to) traffic control (TC) hooks, which attach at a transport layer (e.g., TCP or UDP) to inspect and filter packets during transmission or reception; XDP (eXpress Data Path) hook, which attach at an earliest point in a networking stack to process packets before they reach higher layers. The attached kernel hooks include (but are not limited to) pre-routing hooks (triggered when a packet arrives at the system before routing decisions are made), input hooks (triggered when a packet is destined for the local system), forward hooks (triggered for packets that are being routed through the system), and/or post-routing hooks (triggered after a packet has been routed and is ready to leave the system).

The traffic collection agent 214 monitors the network traffic data from the kernel 212, aggregates and processes the monitored network traffic data in real time to determine network traffic metrics, such as traffic volumes (e.g., bytes transmitted and received per interface, process, or connection), connections, latency (e.g., round-trip time for TCP connections, application-layer response times), packet statistics (packet drops and retransmissions, packet processing time in kernel, checksum errs or malformed packets), bandwidth usage per connection, interface, or process.

The metric exporter 216 is configured to transmit the determined metrics to the automation system 110 for further analysis, visualization, or optimization. The exporter 216 may use network protocols like HTTP, gRPC, or custom communication protocols to transmit the metrics data. In some embodiments, the metric exporter 216 may perform lightweight aggregation and processing of data to reduce transmission overhead.

The automation system 110 includes a network intelligence module 112 configured to receive the collected traffic data from the metric exporter 216 of the node 132. Notably, even though only one node is illustrated in FIG. 2A, there may be multiple nodes 132 in the environment. Each of the multiple nodes 132 may include a traffic collection agent 214 configured to monitor and analyze network traffic data from its kernel 212 and determine network traffic metrics. The network intelligence module 112 receives traffic metrics from each of the multiple nodes 132 to perform further processing and analysis.

These multiple nodes 132 may be part of the same cluster. The nodes may be distributed across different zones or within the same zone. In general, nodes within the same zone perform intra-zone communication with lower latency and lower resource consumption, while nodes in different zones perform cross-zone communication with higher latency and higher resource consumption. The network intelligence module 112 is configured to aggregate network traffic data among different nodes to identify intra-zone communications and cross-zone communications. In some embodiments, the network intelligence module 112 is configured to identify a high-volume cross-zone communication between two nodes and recommend migrating one node to the same zone as the other node to reduce cross-zone communication.

In some embodiments, the multiple nodes 132 may be part of a Kubernetes cluster, including a control plane node and one or more nodes. The control plane node communicates with nodes to schedule workloads or pods to nodes, monitor node health and resource utilization, and manage updates and configurations for nodes.

FIG. 2B is a block diagram of a Kubernetes cluster 210 including a control plane node 132A and one or more nodes 132B, in accordance with one or more embodiments. In each of the control plane node 132A and nodes 132B, a traffic collection agent 214A, 214B is executed in a kernel 212A, 212B to collect traffic flow data associated with a corresponding node 132A, 132B. The control plane node 132A also includes a metrics exporter 216, which receives collected traffic data from its own traffic collection agent 214A and traffic collection agents 214B of nodes 132B. The metrics exporter 216 aggregates the received traffic data and transmits the aggregated traffic data to the automation system 110.

### Example Architecture of Automation System

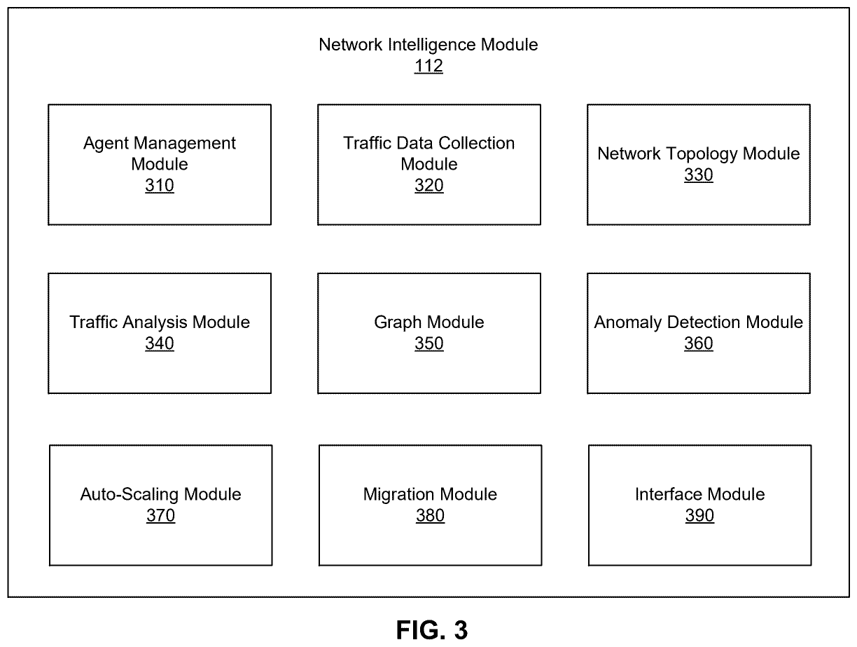

FIG. 3 illustrates an example architecture of a network intelligence module 112, in accordance with one or more embodiments. The network intelligence module 112 includes an agent management module 310, a traffic data collection module 320, network topology module 330, a traffic analysis module 340, a graph module 350, an anomaly detection module 360, an auto-scaling module 370, a migration module 380, and an interface module 390. The modules listed in FIG. 3 are illustrative examples, additional or fewer modules may be implemented in network intelligence module 112. In some embodiments, modules within network intelligence module 112 can be configured flexibly: multiple modules may be combined into one to perform a range of functions, or a single module might be split into several, with each handling a specific subset of tasks. Some functions of these modules are performed by a combination of the automation system 110, the client device 120, and the cloud service provider 130, and/or other devices.

The agent management module 310 is configured to deploy and manage agents 214 on nodes 132 in the cloud environment. In some embodiments, the agent management module 310 is configured to identify nodes in the cloud environment where agents need to be deployed. In some embodiments, the agent management module 310 is configured to query a Kubernetes API or a cloud provider API to retrieve node metadata, such as node name, IP addresses, and zones. In some embodiments, agent management module 310 may also manage agent configuration and updates. The agent management module 310 may configure each agent with proper parameters for deployment of the agent. Such parameters may include (but are not limited to) access credentials for secure communication with the automation system 110, and filters or rules for collecting specific types of network traffic. In some embodiments, the agent management module 310 is configured to generate configuration files to tailor the agent's behavior based on node-specific or workload-specific attributes.

After the agents are deployed, the agent management module 310 may continuously monitor the status of each agent to ensure they are running and functioning as expected. For example, the agent management module 310 may be configure to receive heartbeat signals from each agent to verify their availability, and collects logs from agents to detect issues like crashes or resource exhaustion. In response to detecting agent failures or errors, the agent management module 310 may initiates recovery processes, such as restarting the agent, re-deploying the agent, or alerting an administrator. The agent management module 310 may also be configured to update agents with new configurations or software versions without disrupting the node's workload, and/or apply patches to address bugs or enhance functionality.

The traffic data collection module 320 is configured to collect network traffic metrics from agents 214 running on the nodes. The collected data may include (but is not limited to) source and destination addresses, ports, protocols, traffic volume, and latency. The source and destination addresses may be IP addresses of a sender node and receiver node of data. ports may be endpoints used by network devices to differentiate between multiple nodes or applications running on a same node. For example, HTTP traffic is on port 80. Protocols may be communication protocol used to transmit data, e.g., TCP, UDP, ICMP. Traffic volume is an amount of data sent and received in bytes or packets. Latency is a time taken for packets to travel between two nodes. The agents may implement packet filters or kernel hooks to intercept and analyze network traffic at the kernel to identify retransmitted packets, dropped packets, network-related errors (e.g., connection resets or unreachable destinations), checksum issues (e.g., checking packet headers for invalid checksums), which may also be sent to the traffic data collection module 320.

The network topology module 330 is configured to identify relationships of nodes 132 within the cloud environment, including zones and regions associated with each node 132. In some embodiments, the network topology module 330 periodically queries the cloud provider's APIs to retrieve a list of active nodes, along with their metadata, e.g., node names, regions, zones. The communication paths between different nodes may also be identified based on virtual network configurations, such as virtual private cloud (VPC) peering, and NAT gateways with their metadata.

The traffic analysis module 340 is configured to process the collected network traffic metrics and topology data to determine network traffic flows and their metrics at different granularities, such as process level, pod level, node level, and/or zone level. For example, based on traffic metrics, a network packet from node A to node B is associated with a process, a container, a pod, and a node. Notably, an agent on node A and an agent on node B will both observe this network packet. The agent on node A observes this network packet being transmitted out from node A; the agent on node B observes this network packet being received. The traffic analysis module 340 collects traffic metrics from both node A and node B, and correlate the traffic metrics to identify the traffic flow and its associated process, container, pod, and node. Node A and node B may also communicate with other nodes in the cloud environment. Those traffic metrics are also received by the traffic analysis module 340. The traffic analysis module 340 analyzes traffic metrics received from different nodes to identify traffic flows in different granularity.

Further, the traffic analysis module 340 can also identify a zone of the node based on topology data. As such, the traffic analysis module 340 can also determine whether each traffic flow (regardless of its granularity level) is intra zone or cross zone. In some embodiments, the traffic analysis module 340 is also configured to evaluates metrics such as bandwidth usage, latency, and traffic volume of each traffic flow to identify resource bottlenecks.

The graph module 350 is configured to visualize network traffic flows and entity relationships through dynamic graphs. Each vertex in the graph represents a network entity, such as a process, workload, container, pod, or physical or virtual node, while edges between nodes represents the communication flows between these entities. In some embodiments, edges may further be annotated with critical metrics like bandwidth, latency, and packet loss, providing details insights into the characteristics of each traffic flow. In some embodiments, the graph module 350 allows users to explore network traffic at various levels of granularity, such as process-level, workload-level, container-level, pod-level, and/or a combination views. A user can select a desired granularity level via a graphical user interface (GUI). In response to receiving a user selection of a granularity level, the graph module 350 generates and presents the graph to show the selected layer of the network traffic. For example, a user investigating a high-latency issue can select a process-level granularity to identify a specific process that causes the high latency, while an over view of inter-node traffic might be selected for high-level cost analysis.

In some embodiments, the graph module 350 is configured to real-time monitor network activity by periodically refreshing the graph or triggering updates based on network events. As such, the visualized data reflects the latest state of the network, capturing changes such as new traffic flows, topology updates, or performance anomalies.

The anomaly detection module 360 is configured to identify and alert users to unusual or unexpected patterns in network traffic. In some embodiments, the anomaly detection module 360 monitors metrics such as bandwidth usage, latency, and packet loss. The anomaly detection module 360 may establish expected ranges for these metrics, and in response to detecting that a metric value deviates from the expected range, determines that an anomaly has occurred.

In some embodiments, the anomaly detection module 360 performs contextual analysis to correlate anomalies with contextual information, such as recent changes in the network, updates to configurations, or the deployment of new workloads. Additionally, the anomaly detection module 360 may incorporate adaptive learning capabilities to refine its understanding of normal behavior over time. This allows it to dynamically adjust to changes in the network environment, reducing false positives while maintaining sensitivity to threats.

Unlike static anomaly detection methods that rely on predefined thresholds or rules, adaptive learning may leverage machine learning techniques to continuously refine existing models and enhance detection capabilities. For example, the anomaly detection module 360 may extract features from traffic metrics, such as hourly or daily traffic averages, standard deviations, and confidence intervals. Historical traffic metrics may be clustered into groups representing normal and abnormal patterns. In response to detecting a new traffic pattern sufficiently similar to an abnormal pattern (e.g., a similarity score greater than a predetermined threshold), the anomaly detection module 360 determines that an anomaly has occurred.

The auto-scaling module 370 is configured to dynamically adjust resources in the cloud environment based on real-time network traffic and resource utilization data. The auto-scaling module 370 analyzes traffic metrics to identify when nodes are overloaded or underutilized and triggers actions to add or remove nodes or containers as needed. In some embodiments, the auto-scaling module 370 integrates with Kubernetes' auto-scaling features to optimize resource consumption to ensure that application maintain performance and availability during traffic spikes or drops.

The migration module 380 is configured to facilitate migration of containers, workloads, or zones to optimize performance and reduce cross-zone traffic consumption. In some embodiments, the migration module 380 identifies a cross-zone network traffic flow, and determines whether a volume of the cross-zone network traffic flow is greater than a predetermined threshold. In response to determining that the volume of the cross-zone network traffic flow is greater than the predetermined threshold, the migration module 380 recommends migrating one of the nodes, container, or workloads associated with the interzone traffic flow to a same zone as the other node, container, or workloads associated with the interzone traffic. Alternatively, or in addition, the migration module 380 automatically migrates nodes, containers, and/or workloads to reduce cross-zone network traffic.

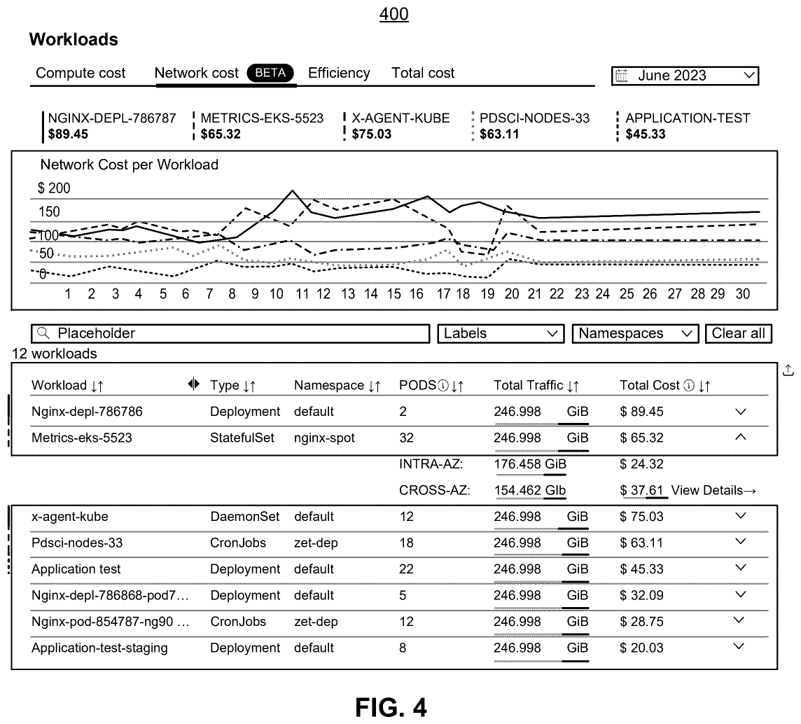

The interface module 390 is configured to provide a graphical user interface (GUI) for interacting with the automation system 110. In some embodiments, the interface module 390 allows users to view network traffic data via graphs, monitor anomalies, and configure auto-scaling and migration policies. Example graphical user interfaces (GUIs) are illustrated in FIGS. 4-8.

### Example Graphical User Interfaces (GUIs)

FIG. 4 illustrates an example graphical user interface (GUI) 400 that provides insights into network costs, traffic, and resource usage across workloads in a Kubernetes-managed environment, in accordance with one or more embodiments. The GUI 400 includes a few navigation tabs at the top, including options for compute cost, network cost, efficiency, and total cost. When the network cost is selected, a top panel displays network costs for individual workloads, such as, Nginx-depl-768787: $89.45, Metrics-EKS-5523: $65.32, X-Agent-Kube: $75.03, Psqci-Nodes-33: $63.11, and Application-Test: $45.33. These values represent a total network costs associated with each workload, which may be determined based on total traffic volume and cross-zone communication.

The GUI 400 also includes a graph section that visualizes the network cost for different workloads over time (e.g., daily across June 2023). The X-axis represents days of the month, and the Y-axis represents network cost (in dollars). Each line corresponds to a workload, allowing users to identify trends, peaks, and anomalies in network costs.

The GUI 400 also includes a workloads table at the bottom. The table includes details about workloads organized into several columns, including workload name, workload type, namespace, pods, total traffic, and total cost. The table also presents details about intra-AZ traffic and cross-AZ traffic. Intra-AZ traffic represents traffic within a same availability zone (e.g., 178.458 GiB) and associated costs (e.g., $24.32). Cross-AZ traffic represents traffic between different availability zones (e.g., 154.452 GiB) and associated costs (e.g., $37.61). Users are allowed to filter workloads by specific labels or namespaces for focused view. A search bar may also allow users to search for specific workloads.

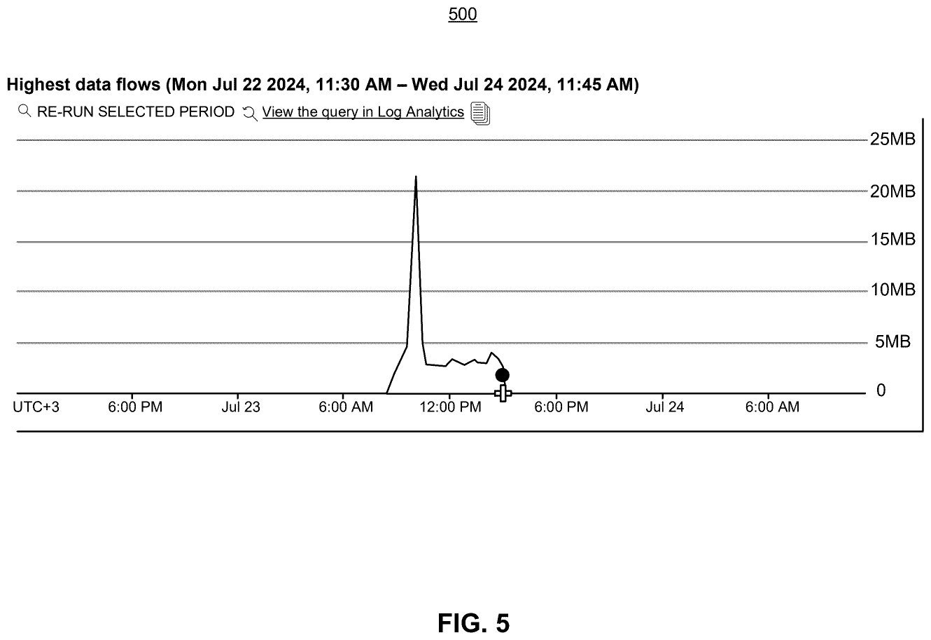

FIG. 5 illustrates another example GUI 500 that visualize highest network traffic data flows over time, in accordance with one or more embodiments. The GUI 500 includes a line graph showing spikes in data flow patterns during a time period between Mon Jul. 22, 2024, 11:30 AM and Wed Jul. 24, 2024, 11:45 AM. Y-axis of the graph measures the data flow rate in megabits per second (Mbps), ranging from 1 to 25 Mbps. X-axis of the graph displays the timeline of the monitored period, with markers for specific dates and times. A notable spike in data flow is visible near 12:00 PM on July 23, reaching a peak of approximately 25 Mbps. After the spike, the data flow stabilizes but remains at a moderate level, declining gradually toward the right of the graph. A dot on the timeline may indicate a detection of an anomaly.

In some embodiments, the graph may be generated in response to a user's query. The user's query may provide a start time and an end time of a time period for generating the graph. Alternatively, or in addition, the user's query may simply request for a graph identifying a most recent anomaly. The graph may be used to notify users a surge in bandwidth usage due to unexpected traffic or a potential security event (e.g., distributed denial of service attack). The graph may also be used to notify user a recommended optimization of resource allocation during peak periods.

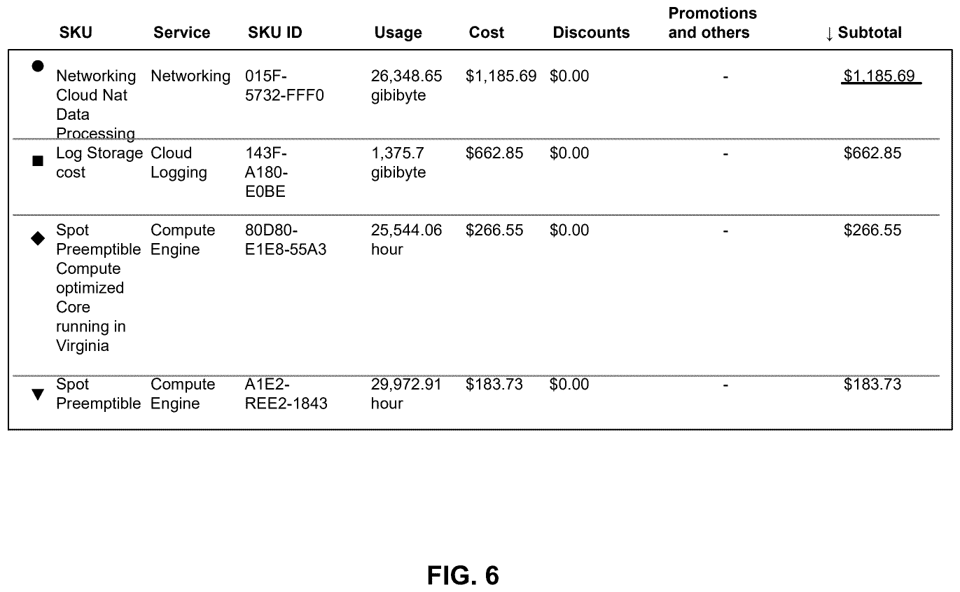

FIG. 6 illustrates another example GUI 600 that lists usage and costs associated with various resources, in accordance with one or more embodiments. The resources include networking, cloud logging, and compute engine. Networking usage for cloud NAT data processing includes 26,348.65 GiB, which incurred a cost of $1185.69.

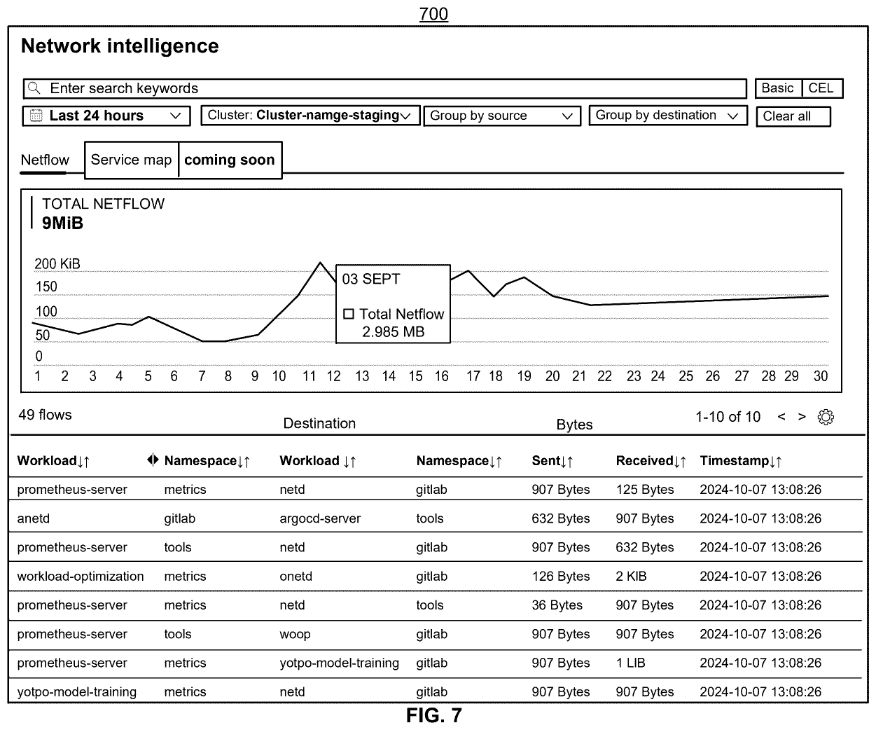

FIG. 7 illustrates another example GUI 700 that provides insights into network traffic in a Kubernetes-managed environment, in accordance with one or more embodiments. The GUI 700 includes a dropdown menu that allows users to group traffic data by attributes. The attributes includes protocol, process, container_name, pod_name, namespace, zone, workload_name, workload_kind, port, etc. Users can toggle these attributes for source or destination to customize how traffic data is aggregated and displayed.

The GUI 700 also includes a graph section and table section. The graph section provides line graphs of the network traffic flows generated based on the selected attributes. The table section provides a table that breaks down network traffic flows, with columns for the attributes. As such, users can review traffic flows between any workloads, namespace, and zones and understand resource usage and identify high-volume traffic flows. Such insights can be used to diagnose issues such as bottlenecks, latency, or unexpected cross-zone traffic. They also can be used to optimize workload placement to reduce network resource consumption (e.g., minimizing cross-zone traffic). The customizable grouping enables users to drill down into specific traffic patterns or focus on particular attributes like pods, processes, or zones.

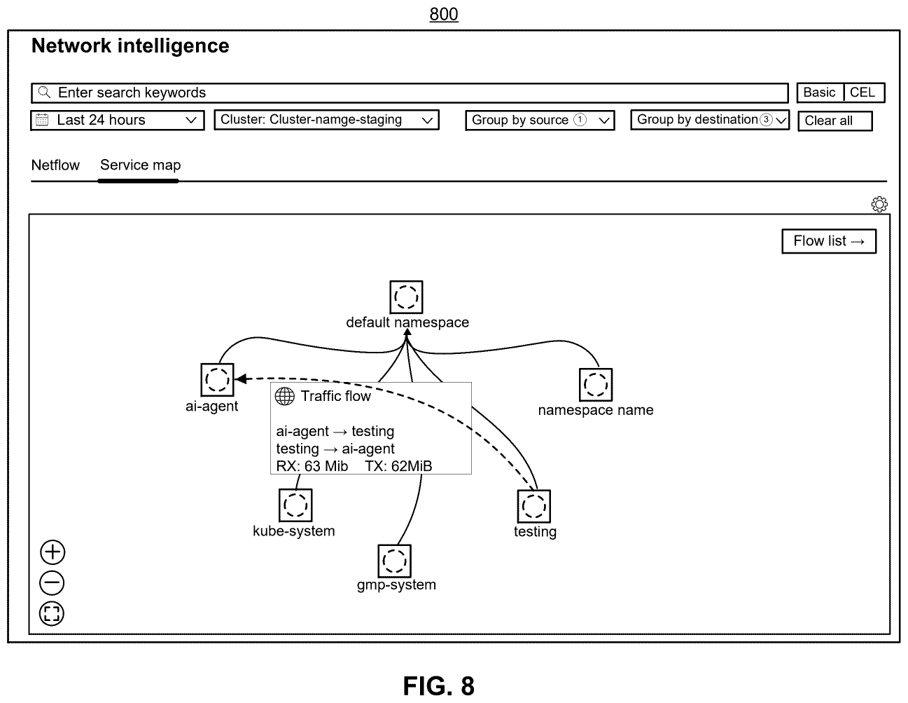

FIG. 8 illustrates an example GUI 800 that visualizes a flow of network traffic between services, nodes and external entities in a Kubernetes or distributed cloud environment, in accordance with one or more embodiments. Each node in the graph represents a service, a pod, or an external endpoint participating in network communication. For example, an internet node represents traffic originating from or destined for the internet; a cluster node indicates specific workloads or namespaces in the cluster; a Kube system node represents Kubernetes system services managing internal operations. The edges and their connections between nodes represent network traffic flows, indicating a direction of data transfer. The edges may be labeled with traffic metrics, such as data transfer volume (e.g., 10 MB in last hour). The graph provides a clear view of traffic patterns. For example, connections from the internet to the cluster nodes indicate inbound traffic. Inter-service communication shows how services within the cluster communicate (e.g., “cluster-agent-controller” sending data to “cluster-agent-ingress”). Traffic from internal nodes to external endpoints (e.g., the internet) indicates outbound traffic.

In some embodiments, users can click on nodes or edges to see more detailed traffic metrics or metadata. Users can also use grouping and filtering options for tailored views, focusing on specific processes, namespaces, or zones. In some embodiments, the graph updates in real-time or near real time to reflect ongoing traffic changes.

### Example Methods for Identifying Process-Level Network Traffic Flows

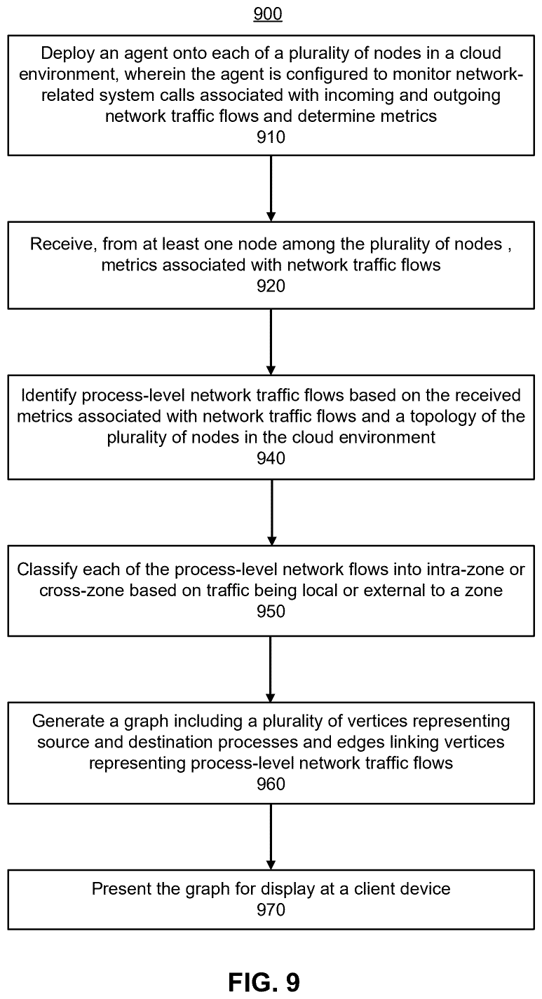

FIG. 9 is a flowchart of a method 900 for identifying process-level network traffic flows in accordance with one or more embodiments. In various embodiments, the method includes different or additional steps than those described in conjunction with FIG. 9. Further, in some embodiments, the steps of the method may be performed in different orders than the order described in conjunction with FIG. 9. The method described in conjunction with FIG. 9 may be carried out by the automation system 110 in various embodiments, while in other embodiments, the steps of the method are performed by any online system capable of performing these steps.

The automation system 110 deploys 910 an agent onto each of a plurality of nodes in a cloud environment. Each agent is executed in a kernel of a corresponding nodes, attached to network-related system calls in the kernel of the corresponding nodes. The agent is configured to monitor data associated with network traffic flows originates from or received by the node, and determine metrics associated with network traffic flows based on the monitored data. The kernel is a core part of an operating system of the node that directly manages hardware resources and system calls. The system calls include opening and closing network sockets, sending and receiving packets, establishing connections between processes and remote endpoints. Running in the kernel allows the agent to intercept and monitor traffic at a more granular level, capturing details about the source and destination entities, and characteristics of the traffic. In some embodiments, the agents use eBPF (Extended Berkeley Packet Filter) to aggregate and process the collected traffic data to determine metrics, such as bandwidth, packet drops, latency, and connection statistics, in the kernel, reducing the need to transfer raw data to user space. The collected traffic metrics are transmitted to the automation system 110.

The automation system 110 receives 920, from each of the plurality of nodes, metrics associated with network traffic flows. In some embodiments, the traffic metrics is transmitted from each node to the automation system 110. In some embodiments, the plurality of nodes forms a cluster that includes a control plane node and one or more nodes. Nodes are the nodes configured to run application workloads. They may host and execute application containers or processes. Control plane node (also referred to control plane) is a management entity configured to orchestrate the operation of the execution of application containers or processes, managing overall state of the cluster. The nodes transmit their traffic metrics to the control plane node, which in turn aggregates the received traffic metrics and then transmits the aggregated traffic metrics to the automation system 110.

The automation system 110 identifies 940 one or more process-level network traffic flows based on the received metrics associated with network traffic flows and a topology of the plurality of nodes in the cloud environment. Process-level network traffic flows represent the data sent or received by individual processes running on nodes in the cloud environment. The metrics determined by agents includes process-level identifiers (e.g., process IDs or names) associated with network activity. For example, for each process-level network traffic flow, there is a source process (which sends data out) and a destination process (which receives the data from the source process). By analyzing these identifiers extracted from traffic metrics from different nodes, the automation system 110 can associate network packets or connections with a source process that generates it, and a destination process that receives it. The automation system 110 can also use the topology to link the source and destination processes to their respective containers, pods, and/or nodes.

In some embodiments, the automation system 110 also determines the topology of the plurality of nodes in the cloud environment based on metadata associated with the plurality of nodes. The topology is a structural layout or arrangement of nodes within the cloud environment, such as how nodes are connected and interact, the geographical or logical grouping of nodes (e.g., availability zones or data center regions), grouping based on workloads, services, or applications running on the nodes. In some embodiments, the automation system 110 may query the cloud environment's APIs to retrieve the metadata about all nodes. The metadata provides descriptive information about each node and its role in the system. Example of metadata includes node-specific metadata, such as instance ID, IP (internet protocol) address, hostname, operating system, resources (e.g., CPU, memory, storage); network metadata, such as subnet and VLAN (virtual local area network) configuration, IP routes and gateways, security group and firewall rules; cloud environment metadata (e.g., region and availability zone, tags (e.g., database-server, web-app), resource group or cluster association.

The automation system 110 classifies 950 each of the process-level network traffic flow into intra-zone or cross zone based on traffic being local or external to a zone. Intra-zone traffic flow refers to traffic between processes that are located within a same availability zone (AZ) in the cloud environment. Each AZ is located in a separate physical data center, which is geographically distinct area from other AZs.

Intra-zone traffic flow typically involves lower latency and resource consumption because the traffic does not travers broader network boundaries, such as crossing regions or zones. Cross-zone traffic flow refers to traffic between processes that are located in different AZs. Cross-zone traffic flow usually incurs higher latency and resource consumption due to the additional network hops required to route traffic between AZs. Accordingly, it is advantageous to identify and reduce cross-zone traffic flows in certain applications.

The automation system 110 generates 960 a graph including the plurality of vertices representing source or destination processes, and edges linking vertices representing process-level network traffic flows. The graph corresponds to the topology of the plurality of nodes, and the edges are annotated to indicate whether the corresponding traffic flows are intra-zone or cross-zone.

In some embodiments, the metrics associated with network traffic flows include (but are not limited to) packet volumes, bandwidth consumption, packet retransmissions, packet drops, and/or latencies. In some embodiments, the graph further includes annotations representing a latency associated with an edge. In some embodiments, the graph further includes annotation representing a bandwidth consumption. In some embodiments, the automation system 110 is further configured to aggregate process-level traffic flows into container-level traffic flows, pod-level traffic flows, and node-level traffic flows, and generate graphs for these different levels of traffic flows.

The automation system 110 presents 970 the graph at a client device for display. The displayed graph may include various interactive features. For example, users may be able to pan across the graph to explore different parts of the topology and zoom in or out to view high-level overviews or detailed traffic flows. In some embodiments, users can toggle between different granularity levels (e.g., process-level, pod-level, node-level, zone-level). In some embodiments, in response to hovering over nodes or edges, the graph displays vertices-specific metadata (e.g., process name, IP address, zone), edge-specific metrics (e.g., bandwidth, latency, packet loss, cross-zone vs. intra-zone status).

In some embodiments, users can select any one of these levels of traffic flows for review. In response to a user selecting a level, the automation system 110 may generate a graph reflecting the selected level of traffic flows. For example, if the pod level is selected, each vertex in the graph represents a pod, and each edge represents traffic between different pods. As another example, if the node level is selected, each vertex in the graph represents a node, and each edge represents traffic between different nodes.

In some embodiments, the graph is dynamically updated in response to changes in the network traffic flows, such as an addition of a new flow and/or termination of an existing flow. In some embodiments, the automation system 110 may identify a first container in a first node associated with a first latency greater than a first predetermined threshold, identify a second container in a second node associated with a second latency lower than a second predetermined threshold, and migrate the first container in the first node to the second node.

As discussed above, cross-zone traffic flow usually incurs higher latency and resource consumption due to the additional network hops required to route traffic between AZs. Accordingly, it is advantageous to identify and reduce cross-zone traffic flows. To reduce cross-zone traffic flows, the automation system 110 may migrate nodes associated with cross-zone traffic flows into a same zone. In some embodiments, in response to determining that a volume of a cross-zone process-level network traffic flow between a first node in a first zone and a second node in a second zone is greater than a threshold, the automation system 110 may migrate a container associated with the cross-zone process-level network traffic flow currently running in the first node in the first zone to the second node in the second zone.

Further, when the network bandwidth usage associated with a node is high, it typically indicates that the node is sending or receiving a large amount of data over its network interface. This condition can lead to increased latency, packet loss, and network slowdown. The automation system 110 may address issues caused by high bandwidth usage through autoscaling. In some embodiments, in response to determining that the bandwidth usage associated with a node exceeds a predetermined threshold, the automation system 110 automatically provisions one or more additional nodes, distributing the workload of the node to the additional nodes.

### Example Computing System

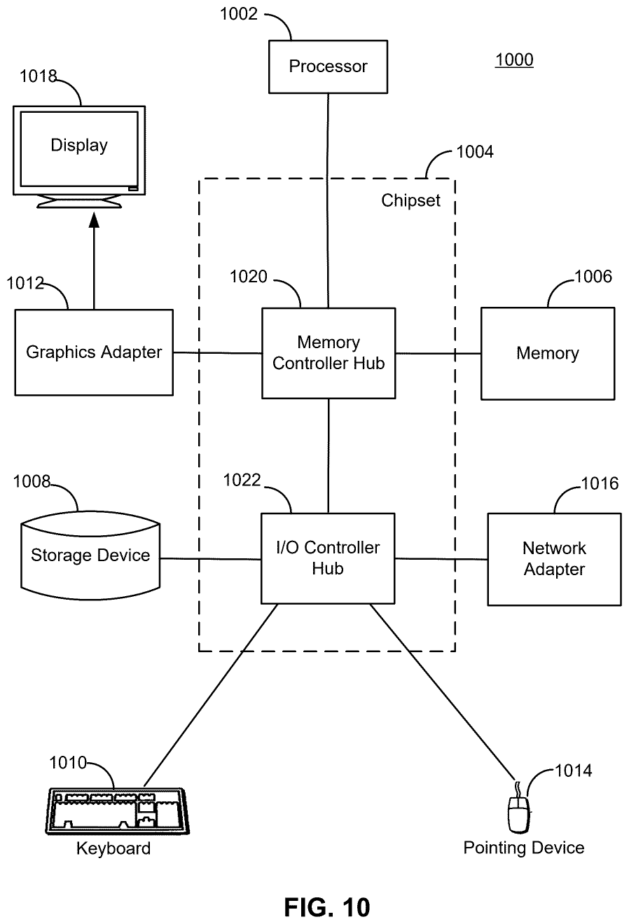

FIG. 10 is a block diagram of an example computer 1000 suitable for use in the networked computing environment 100 of FIG. 1. The computer 1000 is a computer system and is configured to perform specific functions as described herein. For example, the specific functions corresponding to automation system 110 may be configured through the computer 1000.

The example computer 1000 includes a processor system having one or more processors 1002 coupled to a chipset 1004. The chipset 1004 includes a memory controller hub 1020 and an input/output (I/O) controller hub 1022. A memory system having one or more memories 1006 and a graphics adapter 1012 are coupled to the memory controller hub 1020, and a display 1018 is coupled to the graphics adapter 1012. A storage device 1008, keyboard 1010, pointing device 1014, and network adapter 1016 are coupled to the I/O controller hub 1022. Other embodiments of the computer 1000 have different architectures.

In the embodiment shown in FIG. 10, the storage device 1008 is a non-transitory computer-readable storage medium such as a hard drive, compact disk read-only memory (CD-ROM), DVD, or a solid-state memory device. The memory 1006 holds instructions and data used by the processor 1002. The pointing device 1014 is a mouse, track ball, touchscreen, or other types of a pointing device and may be used in combination with the keyboard 1010 (which may be an on-screen keyboard) to input data into the computer 1000. The graphics adapter 1012 displays images and other information on the display 1018. The network adapter 1016 couples the computer 1000 to one or more computer networks, such as network 150.

The types of computers used by the entities and the automation system 110 of FIGS. 1 through 10 can vary depending upon the embodiment and the processing power required by the enterprise. For example, the automation system 110 might include multiple blade servers working together to provide the functionality described. Furthermore, the computers can lack some of the components described above, such as keyboards 1010, graphics adapters 1012, and displays 1018.

### Additional Considerations

The automation system 110 described herein achieves granular monitoring of network traffic with minimal overhead by deploying agents within the kernel of nodes, enabling real-time visibility into bandwidth usage and traffic patterns. The automation system 110 visualizes real-time traffic flow as an interactive and dynamic graph, allowing users to easily review relationships between processes, workloads, containers, pods, and nodes. Furthermore, the automation system 110 utilizes real-time granular monitoring of network traffic to proactively reduce network bottlenecks by identifying high-bandwidth nodes and automatically provisioning additional nodes to distribute workloads. Additionally, the automation system 110 reduces inefficient cross-zone traffic by automatically migrating nodes associated with cross-zone traffic into the same zones.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcodes, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
deploying a plurality of agents in a cloud environment, wherein each agent of the plurality of agent is deployed onto a different node of a plurality of nodes, and
wherein each agent of the plurality of agents is:
executed in a kernel of a node on which the agent is deployed,
attached to network-related system calls in the kernel in which the network-related system calls are executed, and
configured to monitor data associated with network traffic flows that originate from or received by the node and determine metrics associated with network traffic flows on the node based on the monitored data;
receiving, from each of the plurality of nodes, respective metrics associated with network traffic flows on the node determined by the agent deployed on the node;
identifying process-level network traffic flows based on the received metrics associated with network traffic flows and a topology of the plurality of the nodes in the cloud environment;
classifying each of the process-level network flows into intra-zone or cross zone based on traffic being local or external to a zone;
generating a graph based on the identified process-level network traffic flows, the graph including a plurality of vertices representing source or destination processes running on the plurality of nodes, and edges linking the vertices representing process-level network traffic flows, wherein the graph corresponds to the topology of the plurality of nodes, and the edges are annotated to indicate whether the corresponding traffic flows between nodes are intra-zone or cross-zone; and
presenting the graph for display at a client device.

2. The method of claim 1, wherein the metrics associated with network traffic flows include one or more of packet volumes, packet retransmissions, packet drops, and latencies.

3. The method of claim 1, wherein the agent is attached to the network-related system calls in the kernel using eBPF (extended Berkeley Packet Filter) hooks.

4. The method of claim 1, further comprising determining a topology of the plurality of nodes in the cloud environment based on metadata associated with the plurality of nodes, the metadata associated with the plurality of nodes includes one or more of: node names, IP addresses, ports, regions, and zones associated with the plurality of nodes.

5. The method of claim 4, further comprising identifying a plurality of levels of network traffic flows, including one or more of container-level traffic flows, pod-level traffic flows, node-level traffic flows, and zone-level traffic flows.

6. The method of claim 1, wherein the graph is dynamically updated in response to changes in the network traffic flows, including an addition of a new flow or termination of an existing flow.

7. The method of claim 1, further comprising determining one or more network traffic metrics for each edge in the graph, wherein the one or more network traffic metrics include volume, bandwidth usage, latency, and packet loss associated with the corresponding process-level network traffic flow, and the edges of the graph is further annotated with the one or more network traffic metrics.

8. The method of claim 7, the method further comprising:
identifying a first container in a first node associated with a first latency greater than a first predetermined threshold;
identifying a second container in a second node associated with a second latency lower than a second predetermined threshold; and
migrating the first container in the first node to the second node.

9. The method of claim 7, further comprising:
responsive to determining that a volume of a cross-zone network traffic flow between a first node in a first zone and a second node in a second zone is greater than a threshold, migrating a container associated with the cross-zone process-level network traffic flow currently running in the first node in the first zone to the second node in the second zone.

10. The method of claim 7, further comprising:
determining that a bandwidth usage associated with a node is greater than a predetermined threshold; and
automatically provisioning one or more additional nodes, distributing workload in the node to the one or more additional nodes.

11. A non-transitory computer readable storage medium having instructions encoded thereon that, when executed by one or more processors, cause the one or more processors to perform steps comprising:
deploying a plurality of agents in a cloud environment, wherein each agent of the plurality of agent is deployed onto a different node of a plurality of nodes, and
wherein each agent of the plurality of agents is:
executed in a kernel of a node on which the agent is deployed,
attached to network-related system calls in the kernel in which the network-related system calls are executed, and
configured to monitor data associated with network traffic flows that originate from or received by the node and determine metrics associated with network traffic flows on the node based on the monitored data;
receiving, from each of the plurality of nodes, respective metrics associated with network traffic flows on the node determined by the agent deployed on the node;
identifying process-level network traffic flows based on the received metrics associated with network traffic flows and a topology of the plurality of the nodes in the cloud environment;
classifying each of the process-level network flows into intra-zone or cross zone based on traffic being local or external to a zone;
generating a graph based on the identified process-level network traffic flows, the graph including a plurality of vertices representing source or destination processes running on the plurality of nodes, and edges linking the vertices representing process-level network traffic flows, wherein the graph corresponds to the topology of the plurality of nodes, and the edges are annotated to indicate whether the corresponding traffic flows between nodes are intra-zone or cross-zone; and
presenting the graph for display at a client device.

12. The non-transitory computer readable storage medium of claim 11, wherein the metrics associated with network traffic flows include one or more of packet volumes, packet retransmissions, packet drops, and latencies.

13. The non-transitory computer readable storage medium of claim 11, wherein the agent is attached to the network-related system calls in the kernel using eBPF (extended Berkeley Packet Filter) hooks.

14. The non-transitory computer readable storage medium of claim 11, the steps further comprising identifying a plurality of levels of network traffic flows, including one or more of container-level traffic flows, pod-level traffic flows, node-level traffic flows, and zone-level traffic flows.

15. The non-transitory computer readable storage medium of claim 11, further comprising determining a topology of the plurality of nodes in the cloud environment based on metadata associated with the plurality of nodes, the metadata associated with the plurality of nodes includes one or more of: node names, IP addresses, ports, regions, and zones associated with the plurality of nodes.

16. The non-transitory computer readable storage medium of claim 11, the steps further comprising determining one or more network traffic metrics for each edge in the graph, wherein the one or more network traffic metrics include volume, bandwidth usage, latency, and packet loss associated with the corresponding process-level network traffic flow, and the edges of the graph is further annotated with the one or more network traffic metrics.

17. The non-transitory computer readable storage medium of claim 16, the steps further comprising:
identifying a first container in a first node associated with a first latency greater than a first predetermined threshold;
identifying a second container in a second node associated with a second latency lower than a second predetermined threshold; and
migrating the first container in the first node to the second node.

18. The non-transitory computer readable storage medium of claim 16, the steps further comprising:
responsive to determining that a volume of a cross-zone network traffic flow between a first node in a first zone and a second node in a second zone is greater than a threshold, migrating a container associated with the cross-zone process-level network traffic flow currently running in the first node in the first zone to the second node in the second zone.

19. The non-transitory computer readable storage medium of claim 16, the steps further comprising:
determining that a bandwidth usage associated with a node is greater than a predetermined threshold; and
automatically provisioning one or more additional nodes, distributing workload in the node to the one or more additional nodes.

20. A system, comprising:
one or more processors; and
a non-transitory computer readable storage medium having instructions encoded thereon that, when executed by the one or more processors, cause the one or more processors to perform steps comprising:
deploying a plurality of agents in a cloud environment, wherein each agent of the plurality of agent is deployed onto a different node of a plurality of nodes, and wherein each agent of the plurality of agents is:
executed in a kernel of a node on which the agent is deployed,
attached to network-related system calls in the kernel in which the network-related system calls are executed, and
configured to monitor data associated with network traffic flows that originate from or received by the node and determine metrics associated with network traffic flows on the node based on the monitored data;
receiving, from each of the plurality of nodes, respective metrics associated with network traffic flows on the node determined by the agent deployed on the node;
identifying process-level network traffic flows based on the received metrics associated with network traffic flows and a topology of the plurality of the nodes in the cloud environment;
classifying each of the process-level network flows into intra-zone or cross zone based on traffic being local or external to a zone;
generating a graph based on the identified process-level network traffic flows, the graph including a plurality of vertices representing source or destination processes running on the plurality of nodes, and edges linking the vertices representing process-level network traffic flows, wherein the graph corresponds to the topology of the plurality of nodes, and the edges are annotated to indicate whether the corresponding traffic flows between nodes are intra-zone or cross-zone; and
presenting the graph for display at a client device.
